(19) United States
(12) Patent Application Publication
(10) Pub. No.: US 2002/0122651 A1
(43) Pub. Date: Sep. 5, 2002

(54) Controlling birefringence in an optical waveguide and in an arrayed waveguide grating

(75) Inventor: Stephen William Roberts, Winchester Hants (GB)

Correspondence Address: SUGHRUE MION, PLLC, 2100 Pennsylvania Avenue, N.W., Washington, DC, 20037-3213, US

(73) Assignee: BOOKHAM TECHNOLOGY PLC

(21) Appl. No.: 10/050,575

(22) Filed: Jan. 18, 2002

Related U.S. Application Data
(63) Continuation-in-part of application No. 09/708,452, filed on Nov. 9, 2000.

(30) Foreign Application Priority Data
Sep. 26, 2000 (GB) 0023558.0
Aug. 25, 2001 (GB) PCT/GB01/04270

(51) Int. Cl. G02B 6/10; G02B 6/27

(52) U.S. Cl. 385/132; 385/141; 385/11

(57) ABSTRACT

A method of controlling birefringence in a rib waveguide structure manufactured in silicon, the rib waveguide structure comprising an elongated rib element having an upper face and two side faces, the method comprising forming a layer of thermal oxide to a predetermined thickness on said upper face and side faces of at least a portion of said rib waveguide structure.

The present invention relates to controlling birefringence in an optical waveguide, particularly a silicon rib waveguide structure, and also to controlling birefringence in an arrayed waveguide grating.

### BACKGROUND OF THE INVENTION

As is well known, birefringence represents a significant problem in optical waveguides. Birefringence can result from a number of different sources each of which causes light polarised in a different manner to be subjected to different refractive indices. This results in light of different polarisations being transmitted differently by the waveguide with the result that the behaviour of a device receiving light with a random polarisation, and in particular transmission losses, become unpredictable. Some well known sources of birefringence are the crystalline structure of waveguides, the shape of the waveguide (in terms of its light guiding cross section), and stress and strain induced as a result of any bends, substrate discontinuations etc. in the path of the waveguide.

Rib waveguide structures manufactured on a silicon-on-insulator chip are known. One such arrangement is described for example in PCT Patent Specification No. WO95/08787. This form of waveguide provides a single mode, low loss (typically less than 0.2 dB/cm for the wavelength range 1.2 to 1.6 microns) waveguide typically having dimensions in the order of 3 to 5 microns which can be coupled to optical fibres and which is compatible with other integrated components. This form of waveguide can also be easily fabricated from conventional silicon-on-insulator wafers (as described in WO95/08787 referred to above) and so is relatively inexpensive to manufacture. It is an aim of the invention to control birefringence in structures of this type.

In an arrayed waveguide grating of the kind shown in plan view in FIG. 6, birefringence can lead to polarisation-dependent frequency (PDF), which can be seen experimentally as a shift in passband centre frequency as the transmitted light polarisation is changed—see FIG. 8. It is another aim of the present invention to control polarisation-dependent frequency effects in structures of this type.

### SUMMARY OF THE INVENTION

It has been found that when a layer of thermal oxide is formed on a silicon rib waveguide structure, it induces a physical stress that effects the relative transmission of the TM and TE polarisations in an opposite way to the overall effect of the sources of birefringence inherent in the silicon rib waveguide. It has also been found that the degree to which the stress-inducing thermal oxide layer effects the relative transmission of the TM and TE polarisations depends on the thickness to which the thermal oxide is formed.

According to one aspect of the present invention there is provided a method of controlling birefringence in a rib waveguide structure manufactured in silicon, the rib waveguide structure comprising an elongated rib element having an upper face and two side faces, the method including providing a layer of thermal oxide to a predetermined thickness on said upper face and side faces of at least a portion of said rib waveguide structure.

According to one embodiment, the layer of thermal oxide is provided on a portion of the waveguide structure, the thickness of the thermal oxide layer and the length of the portion of the waveguide structure over which it is formed being selected so as to substantially eliminate birefringence in the waveguide structure.

However, depending on the application to which the optical device comprising the rib waveguide structure is used, the thermal oxide layer may be formed so as to leave the waveguide with a controlled, predetermined, no-zero level of birefringence, which may be greater or smaller than the birefringence of the waveguide before the thermal oxide layer was formed.

According to another aspect of the present invention, there is provided the use of a layer of thermal oxide in a method of fabricating a rib waveguide structure in silicon to control birefringence by forming said layer to a predetermined thickness on at least a portion of said rib waveguide structure.

According to another aspect of the present invention, there is provided a method of manufacturing a silicon rib waveguide structure comprising: forming an elongated rib element in a silicon substrate, the elongated rib element having an upper face and two side faces; and providing a layer of thermal oxide to a predetermined thickness on said upper face and side faces on at least a portion of said elongated rib element, the predetermined thickness being selected such as to control birefringence in the rib waveguide structure.

According to another aspect of the present invention, there is provided a method of manufacturing a silicon rib waveguide structure, the method comprising: forming a plurality of optical components in a silicon substrate, said optical components including at least one elongate rib element having an upper face and two side faces; growing a layer of thermal oxide on said plurality of optical components; selectively etching the oxide layer from one or a set of said optical components, but retaining the thermal oxide layer over said at least elongate rib element at least in a portion thereof, wherein the thickness of the layer of thermal oxide is selected to control birefringence in the elongate rib element.

According to another aspect of the present invention, there is provided an interferometric optical device including at least two rib waveguide structures manufactured in silicon and of different path lengths and inherent birefringences, wherein a layer of thermal oxide is provided on at least a portion of at least one of the two rib waveguide structures so as to substantially equalize the birefringence of the two rib waveguide structures.

According to another aspect of the present invention, there is provided an optical device including an array waveguide grating comprising an array of rib waveguide structures manufactured in silicon and having different path lengths and different inherent birefringences, each rib waveguide structure comprising an elongated rib element having an upper face and two side faces, wherein a layer of thermal oxide is provided on the upper and side faces of at least a portion of at least some of the elongated rib elements so as to substantially equalize the birefringence of each of the rib waveguide structures.

In this aspect of the present invention, the thermal oxide layer is formed so as to reduce the polarisation-dependent frequency shift to substantially zero. Alternatively, in a method of controlling birefringence in an array waveguide grating according to the present invention, the thermal oxide layer may be formed so as to control the polarisation dependent frequency shift to a predetermined, non-zero amount, which may be more or less than the polarisation dependent frequency prior to formation of the thermal oxide layer, depending on the application to which the array waveguide grating is to be used.

According to another aspect of the present invention, there is provided the use of a layer of thermal oxide in a method of fabricating an array waveguide grating comprising an array of rib waveguide structures in silicon to control birefringence by forming said layer to a predetermined thickness on at least a portion of at least some of said rib waveguide structures.

According to another aspect of the present invention, there is provided a method of manufacturing an array waveguide grating comprising an array of silicon rib waveguide structures comprising: forming an array of elongated rib elements in a silicon substrate, each elongated rib element having an upper face and two side faces; and providing a layer of thermal oxide to a predetermined thickness on the upper and side faces of at least a portion of at least some of said elongated rib elements, the predetermined thickness being selected such as to control birefringence in the array waveguide grating.

According to another aspect of the present invention, there is provided a method of manufacturing an integrated optical device, the method comprising: forming a plurality of optical components in a silicon substrate, said optical components including an arrayed waveguide grating comprising an array of elongate rib elements, each having an upper face and two side faces; growing a layer of thermal oxide over said plurality of optical components; and selectively etching the oxide layer from one or a set of said optical components, but retaining the thermal oxide layer over said array of elongate rib elements at least in a portion thereof, wherein the thickness of the layer of thermal oxide is selected to control birefringence in the array of elongate rib elements.

According to another aspect of the present invention, there is provided an integrated optical device, comprising a plurality of optical components formed in a silicon substrate, said optical components including an arrayed waveguide grating comprising an array of elongate rib elements, each having an upper face and two side faces; and a layer of thermal oxide on at least a portion of said array of elongate rib elements, the thickness of the layer of thermal oxide being selected to control birefringence in the array of elongate rib elements; wherein at least one of the plurality of optical components is exposed through the thermal oxide layer.

### BRIEF DESCRIPTION OF THE DRAWINGS

For a better understanding of the present invention and to show how the same may be carried into effect, reference will now be made by way of example to the accompanying drawings, in which:

FIGS. 1 to 3 illustrate steps in manufacturing methods of a rib waveguide structure;

FIG. 4 illustrates an improved non-birefringent structure;

FIG. 5 illustrates schematically an improved non-birefringent array of waveguides for an arrayed waveguide grating;

FIG. 5a is a schematic view of a portion of an arrayed waveguide grating produced according to the present invention;

FIG. 6 shows a schematic plan view of an arrayed waveguide grating produced according to the present invention;

FIG. 7 shows a graph of mean PDF shift v. array waveguide nominal separation for different thermal oxide thicknesses; and

FIG. 8 shows a graph showing how the passband frequency can change with the polarisation in an arrayed waveguide grating.

### DESCRIPTION OF THE PREFERRED EMBODIMENTS

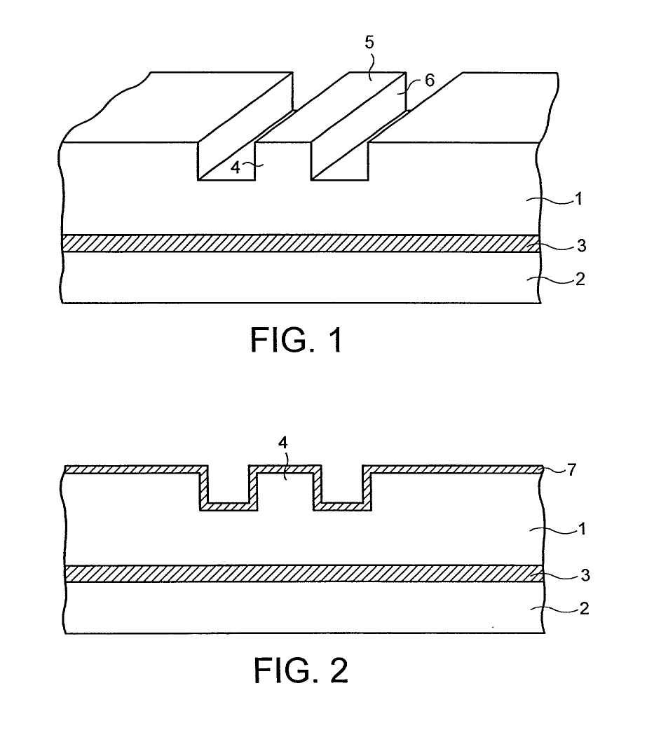

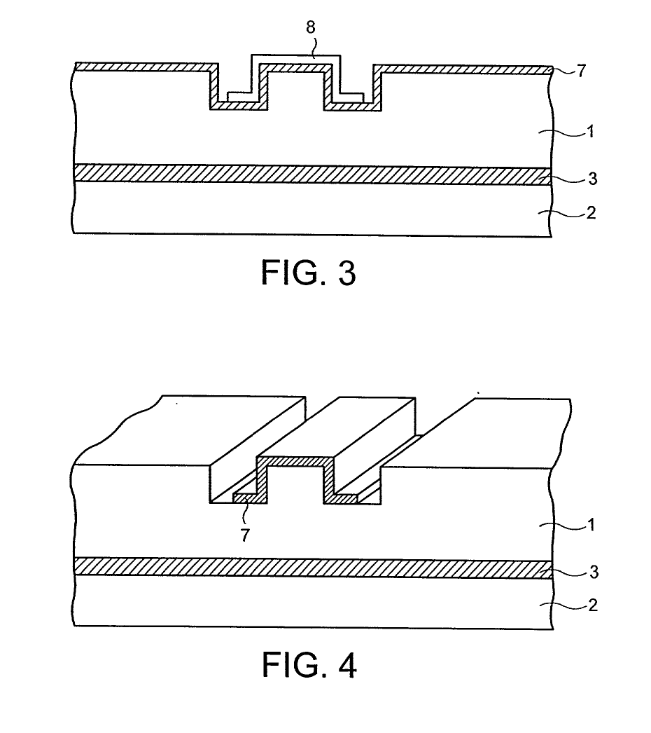

A method of making a silicon rib waveguide structure in accordance with a preferred embodiment of the invention is described. The waveguide structure described herein is based on a silicon-on-insulator chip. A process for forming this type of chip is described in a paper entitled “Reduced defect density in silicon-on-insulator structures formed by oxygen implantation in two steps” by J. Morgail et al, Appl. Phys. Lett., 54, p526, 1989. This describes a process for making a silicon-on-insulator wafer. The silicon layer of such a wafer is then increased, for example by epitaxial growth, to make it suitable for forming the basis of the integrated waveguide structure described herein. FIG. 1 shows a cross section through such a silicon-on-insulator wafer in which an elongated rib element has been formed. The wafer or chip comprises a layer of silicon 1 which is separated from silicon substrate 2 by a layer of silicon dioxide 3. The elongated rib element 4 is formed in the silicon layer 1 by etching.

The width of the elongated rib element is typically in the order of 1 to 10 microns, more particularly 3 to 5 microns.

It is a problem in guiding optical waves that birefringent materials demonstrate a different refractive index for different light polarisations. In waveguide structures where it is difficult or impossible to control the polarity of the guided light, this can present a significant problem and in particular can be the cause of significant losses. It has been found that a thermal oxide layer can be used, for example, to substantially reduce or practically eliminate birefringence of a rib waveguide structure as described herein.

In a subsequent processing step, a layer of oxide is formed by thermal growth at 1050° C. This layer is denoted 7 in FIG. 2. In FIG. 2 like numerals denote like parts as in FIG. 1.

The growth of the thermal oxide takes place over the whole surface of the wafer, which may incorporate a number of silicon waveguides and other optical components. The wafer may have other integrated optical components formed on it. Photoresist 8 is put down over the wafer and then etched away from selected portions of the wafer. Thus, photoresist portions 8 are left over those parts of the wafer where a thermal oxide layer is required.

Subsequently an HF etch is carried out to remove the unprotected parts of the thermal oxide layer 7, leaving a layer on the upper face 5 and side faces 6 of the elongated rib element 4.

The finished structure is as illustrated in FIG. 4. That is, a layer of thermal oxide is left in the finished structure on the upper face and side faces 5,6 of the elongated rib element 4.

According to one embodiment, the thermal oxide is left on the upper and side faces of only a selected portion of the elongated rib element. The thickness of the thermal layer is selected such that the portion of the waveguide on which the thermal oxide is provided has a birefringence of opposite sign to the portion of the waveguide not provided with a thermal oxide layer. For example, it has been determined from experiment that the birefringence of a waveguide having a ridge height of 4.3 μm, a ridge width of 5.8 μm and an etch depth of 1.7 μm is reduced from +3.1×10⁻⁴ to −0.55×10⁻⁴ (where birefringence is defined as n_{TE}−n_{TM}) by the provision of a 0.35 micron thermal oxide layer wet-grown at 1050° C., and that the birefringence of a waveguide having a ridge height of 4.3 μm, a ridge width of 3.8 μm and an etch depth of 2.3 μm is reduced from +1.8×10⁻⁴ to −6.4×10⁻⁴ by the provision of such a thermal oxide layer. The relative length of the portion of the elongated rib element provided with the thermal oxide layer is selected such that the overall birefringence of the waveguide is substantially zero. For example, if the portion of the waveguide on which the thermal oxide is provided has a birefringence of magnitude 5 times greater than the portion of the waveguide without the thermal oxide layer, then the length of the portion on which the thermal oxide layer is provided is selected to be one-fifth (⅕) of the length of the portion without the thermal oxide layer so as to substantially eliminate birefringence for the waveguide as a whole.

In an alternative embodiment, a blanket layer of thermal oxide is left on the upper and side faces of the entire elongated rib element, and the thickness of the thermal oxide layer is selected such that the overall birefringence of the waveguide is substantially zero.

Although not shown as a feature of the embodiment described above, the thermal oxide layer may be left over the whole surface of the silicon substrate. It is thought that varying the extent to which the thermal oxide layer extends over the substrate flanks may also be used to control birefringence in the waveguide.

The application of the present invention to controlling birefringence in array waveguide gratings shall now be described, also by way of example only.

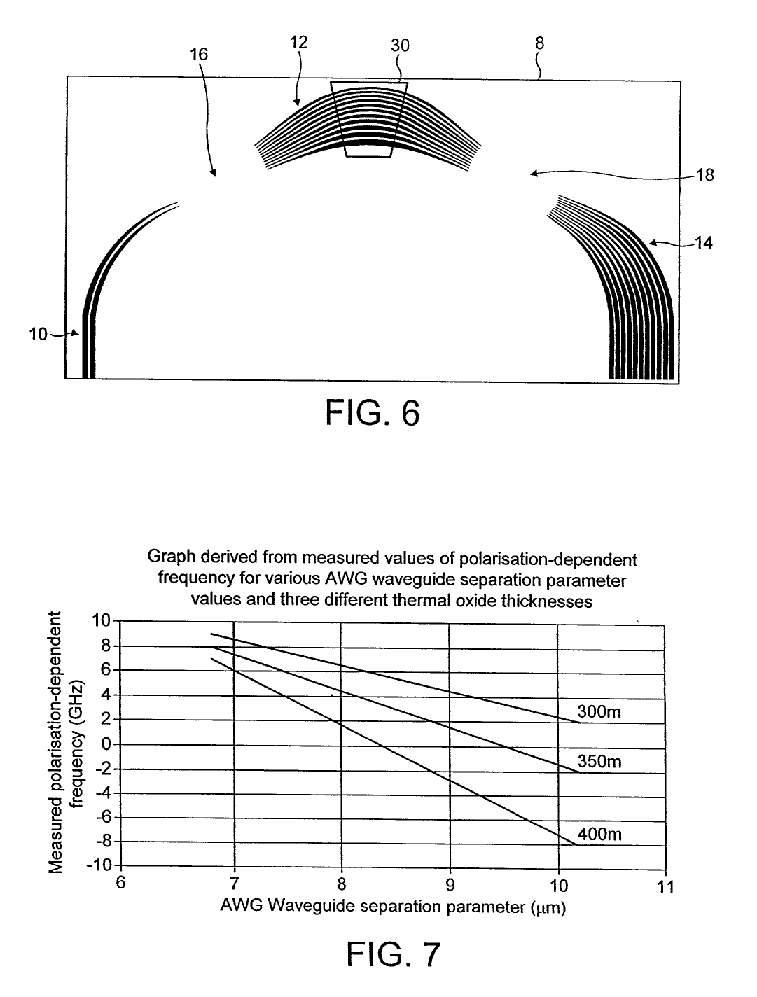

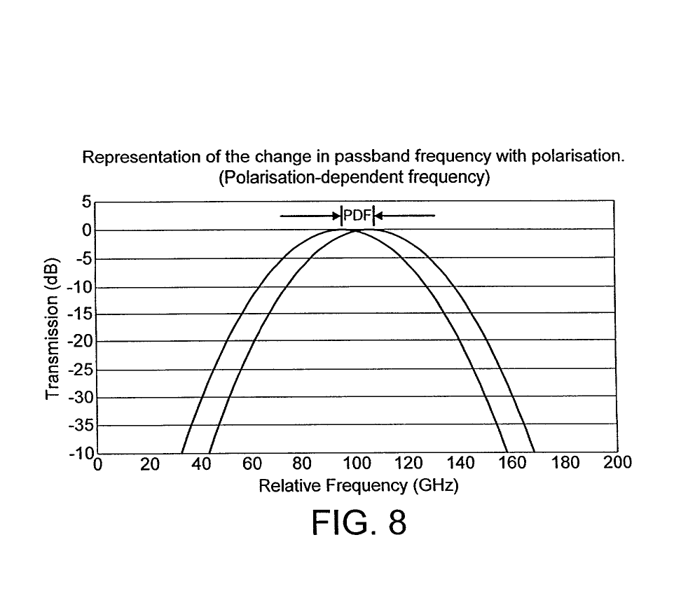

Integrated optical components such as demultiplexers comprise an arrayed waveguide grating such as the one schematically shown in schematic plan view in FIG. 6. Such a grating typically comprises a silicon-on-insulator wafer 8 of the kind described above having an input rib waveguide 10 separated by a first free propagation region 16 from an array of rib waveguides 12 whose optical lengths increase in fixed increments, and a set of output rib waveguides 14 separated from the array of rib waveguides by a second free propagation region 18. The output rib waveguides are aligned in parallel at the edge of the wafer 8. The rib waveguides are defined by grooves etched in the epitaxial silicon layer, which are shown in black in FIG. 6.

As mentioned above, birefringence in the waveguides can lead to polarization-dependent frequency effects, which can be seen experimentally as a shift in pass-band centre frequency. The inventors of the present invention have found that these effects can be controlled by growing a thermal oxide layer on the array of rib waveguides.

An array of waveguides may be formed under the following conditions. A layer of silicon is epitaxially grown to a thickness of 1 μm to 10 μm, and then trenches are etched to a depth corresponding to 10% to 90% of the thickness of the epitaxial silicon to leave an array of ribs having a width in the range of 1 μm to 10 μm and a separation in the range of 1 μm and 50 μm. A layer of thermal oxide is then formed over the entire array at an oxide growth temperature in the range of 800° C. to 1200° C. to a thickness in the range of 0.01 μm to 1.0 μm.

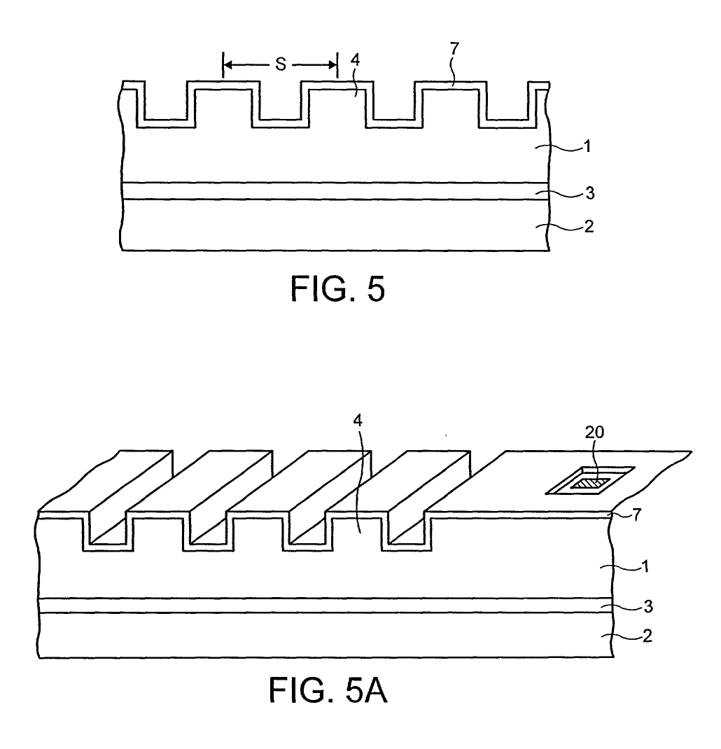

A schematic-cross-sectional view of a waveguide provided with such a thermal oxide layer is shown in FIG. 5. Only three waveguides have been shown, although the array will typically comprise more waveguides. In FIG. 5, like numerals denote like parts as in FIG. 4.

According to one embodiment as shown in FIG. 6, the thermal oxide layer is etched away from selected portions of the array waveguide grating by the techniques described above to leave a truncated triangular thermal oxide patch 30 on a selected portion of the array waveguide grating.

Owing to their different lengths and degrees of curvature, each waveguide of the array waveguide grating has a different inherent structural birefringence. The thermal oxide patch 30 is configured such that the overall birefringence in each waveguide of the array is substantially the same. The thermal oxide layer reduces the birefringence of the portion of the waveguide on which it is formed (where birefringence is defined as the difference in refractive index between the TE and the TN modes, i.e. n_{TE}−n_{TM}.) The inherent structural birefringence is greater for the longer waveguides of the array. Accordingly, as shown in FIG. 6, the thermal oxide patch is configured such that the length of the portion of each waveguide provided with the thermal oxide layer increases with increasing length of the waveguide so as to compensate for the difference in inherent birefringence between the waveguides of the array. The thickness of the thermal oxide layer and the configuration of the patch is selected such that each waveguide of the array has a substantially common level of overall birefringence or substantially zero overall birefringence.

In an alternative embodiment, a blanket layer of thermal oxide is left over the entire array waveguide grating, and the thickness of the thermal oxide layer is selected to reduce the polarisation dependent frequency shift to zero (or to another predetermined amount, depending on the application to which the array waveguide grating is to be used).

For example, results have been achieved with a silicon epitaxial thickness of 4.3 μm, an etch depth corresponding to 40% of the silicon thickness, a rib waveguide width of 4 μm or 6 μm, a waveguide separation in the range of 5 μm to 15 μm, and a thermal oxide layer grown at a temperature of 1050° C. to a thickness of 0.35 μm.

A plot of measured PDF shift v array waveguide nominal separation for three different thermal oxide layer thickness is shown for such an embodiment in FIG. 7. The results on which the graph of FIG. 7 are based were achieved for an arrayed waveguide grating in which the separation between the individual waveguides in the array varies in a complex manner in order to provide the required incremental increase in optical length between adjacent waveguides. The separation of the waveguides where they join the second free propagation region are constant, and the waveguide nominal separation referred to here is the separation at this point which is considered to equate approximately to the average separation between the waveguides. The separation referred to here refers to the distance between the centres of adjacent waveguides as shown as S in FIG. 5.

The wafer in which the arrayed waveguide grating is formed may also comprise other additional optical components manufactured in silicon. In such an embodiment, the thermal oxide layer may be formed on the arrayed waveguide grating and the additional optical components, followed by selective etching to expose the additional optical components. FIG. 5a illustrates schematically a portion of an arrayed waveguide grating showing a portion of the thermal oxide layer having been removed to expose an additional optical component 20.

What is claimed is:

1. A method of controlling birefringence in a rib waveguide structure manufactured in silicon, the rib waveguide structure comprising an elongated rib element having an upper face and two side faces, the method including:
providing a layer of thermal oxide to a predetermined thickness on said upper face and side faces of at least a portion of said elongated rib element.

2. A method according to claim 1, including providing a layer of thermal oxide on the upper face and side faces of a portion of the elongated rib element, the thickness of the thermal oxide layer and the length of the portion of the elongated rib element over which it is formed selected so as to substantially eliminate birefringence in the waveguide structure.

3. Use of a layer of thermal oxide in a method of fabricating a rib waveguide structure in silicon to control birefringence by forming said layer to a predetermined thickness on at least a portion of said rib waveguide structure.

4. A method of manufacturing a silicon rib waveguide structure comprising:
forming an elongated rib element in a silicon substrate, the elongated rib element having an upper face and two side faces; and
providing a layer of thermal oxide to a predetermined thickness on said upper face and side faces on at least a portion of said elongated rib element, the predetermined thickness being selected such as to control birefringence in the rib waveguide structure.

5. A method of manufacturing a silicon rib waveguide structure, the method comprising:
forming a plurality of optical components in a silicon substrate, said optical components including at least one elongate rib element having an upper face and two side faces;
growing a layer of thermal oxide on said plurality of optical components;
selectively etching the oxide layer from one or a set of said optical components, but retaining the thermal oxide layer over said at least elongate rib element at least in a portion thereof, wherein the thickness of the layer of thermal oxide is selected to control birefringence in the elongate rib element.

6. An interferometric optic device including at least two rib waveguides structures manufactured in silicon and having different path lengths and inherent birefringences, each rib waveguide structure comprising an elongated rib element having an upper face and two side faces, wherein a layer of thermal oxide is provided on at least a portion of at least one of the two elongated rib elements so as to substantially equalize the birefringence of the two rib waveguide structures.

7. An optic device including an array waveguide grating comprising an array of rib waveguide structures manufactured in silicon and having different path lengths and different inherent birefringences, each rib waveguide structure comprising an elongated rib element having an upper face and two side faces, wherein a layer of thermal oxide is provided on the upper and side faces of at least a portion of at least some of the elongated rib elements so as to substantially equalize the birefringence of each of the rib waveguide structures.

8. Use of a layer of thermal oxide in a method of fabricating an arrayed waveguide grating comprising an array of rib waveguide structures in silicon to control birefringence by forming said layer to a predetermined thickness on at least a portion of at least some of said rib waveguide structures.

9. A method of manufacturing an arrayed waveguided grating comprising an array of silicon rib waveguide structures comprising,
forming an array of elongated rib elements in a silicon substrate, each elongated rib element having an upper face and two side faces; and
providing a layer of thermal oxide to a predetermined thickness on the upper and side faces of at least a portion of at least some of said elongated rib elements, the predetermined thickness being selected such as to control birefringence in the arrayed waveguide grating.

10. A method according to claim 9 wherein the array of rib waveguide structures are formed by forming an array of elongate trenches extending below a surface of the silicon substrate, the side walls of the trenches defining the side faces of the elongate rib elements, and the upper faces of the elongated rib elements coinciding with said surface of the silicon substrate.

11. A method of manufacturing an integrated optical device, the method comprising:
forming a plurality of optical components in a silicon substrate, said optical components including an arrayed waveguide grating comprising an array of elongate rib elements, each having an upper face and two side faces;
growing a layer of thermal oxide over said plurality of optical components; and
selectively etching the oxide layer from one or a set of said optical components, but retaining the thermal oxide layer over said array of elongate rib elements at least in a portion thereof, wherein the thickness of the layer of thermal oxide is selected to control birefringence in the array of elongate rib elements.

12. An integrated optical device, comprising a plurality of optical components formed in a silicon substrate, said optical components including an arrayed waveguide grating comprising an array of elongate rib elements, each having an upper face and two side faces; and a layer of thermal oxide on at least a portion of said array of elongate rib elements, the thickness of the layer of thermal oxide being selected to control birefringence in the array of elongate rib elements; wherein at least one of the plurality of optical components is exposed through the thermal oxide layer.
